(19) United States
(12) Patent Application Publication
(10) Pub. No.: US 2015/0151564 A1
(43) Pub. Date: Jun. 4, 2015

(54) Floral Expressions

(71) Applicant: Katrina Jones, Hanover Park, IL (US)

(72) Inventor: Katrina Jones, Hanover Park, IL (US)

(21) Appl. No.: 14/095,965

(22) Filed: Dec. 3, 2013

(51) Int. Cl. B43K 7/00; B43K 29/00

(52) U.S. Cl. CPC B43K 7/005; B43K 29/00

(57) ABSTRACT

An elegant floral arrangement featuring a ball point pen incorporated into the stem of some of the flowers, wherein the barrel of the pen features a flexible shaft, thus enabling the user to easily manipulate the pen to create a designated floral arrangement is provided.

### CLAIM OF PRIORITY

This patent application claims priority under 35 USC 119 (e) (1) from U.S. Provisional Patent Application Ser. No. 61/732,430 filed Dec. 3, 2012, of common inventorship herewith entitled, “Floral Expressions.”

### FIELD OF THE INVENTION

This invention relates generally to floral expressions and, more particularly, the invention relates to floral expressions providing a specially designed line of faux flowers for use in creating elegant arrangements and featuring a ball point pen incorporated into the stem of the flower.

### BACKGROUND OF THE INVENTION

### Description of the Prior Art

The prior art has put forth several designs for a faux flower incorporating a pen into its stem. Among these are:

U.S. Design Pat. D328,310 to Shigeo Yoshinaga shows a retractable ball point pen having a flower attached to its distal end.

U.S. Pat. No. 4,678,206 to Daniel P. Leahan describes a combination pen and note pad holder with the pad being formed in the shape of an open flower blossom and the pad adhered to a base member having the same flower shaped peripheral design.

U.S. Pat. No. 6,773,188 to Pia Tamaye describes flower pot pens wherein a pen holder in the form of a potted plant has a housing resembling a plant pot having a filler supporting potted plant material such as pebbles with a receptacle extending into the filler forming a cavity for the insertion therein of a pen and wherein the distal end of the pen has a decorative element such as a flower.

None of these references describe the present invention.

An extremely simple and beautiful way in which to accentuate any home or office decor is by utilizing flowers. Whether a glass vase filled with fresh roses, a dramatic floral arrangement comprised of lilies, gardenias and baby's breath, or a colorful clay pot full of daisies; flowers offer a simple means of adding a splash of lively color and beauty to any room environment. While fresh flowers offer a lovely and fragrant means of enhancing a room's atmosphere, many consumers find that faux flowers offer a long-lasting and more affordable alternative. Faux flowers last year round, maintaining their vibrant color and shape from one season to the next. Manufactured of fancy silk or even malleable plastic material, faux flowers can be used to adorn a holiday table or add a simple elegant touch to a night stand, desk or bureau.

### SUMMARY OF THE INVENTION

It is an object of the present invention to provide a floral arrangement of artificial flowers wherein some of the flowers incorporate a pen into the stem of the flower.

It is an object of the present invention to provide an elegant floral arrangement featuring a ball point pen incorporated into the stem of the flower, wherein the barrel of the pen features a flexible shaft, thus enabling the user to easily manipulate the pen to create a designated floral arrangement.

### BRIEF DESCRIPTION OF THE DRAWINGS

FIG. 1 shows a perspective view illustrating the shaft of a pen having a flower at its distal end.

FIG. 2 shows an floral arrangement of floral expressions, constructed in accordance with the present invention, showing a bouquet of flowers, some of which have pens as stems and a single flower with pen stem laying next to the arrangement.

### DETAILED DESCRIPTION OF THE PREFERRED EMBODIMENTS

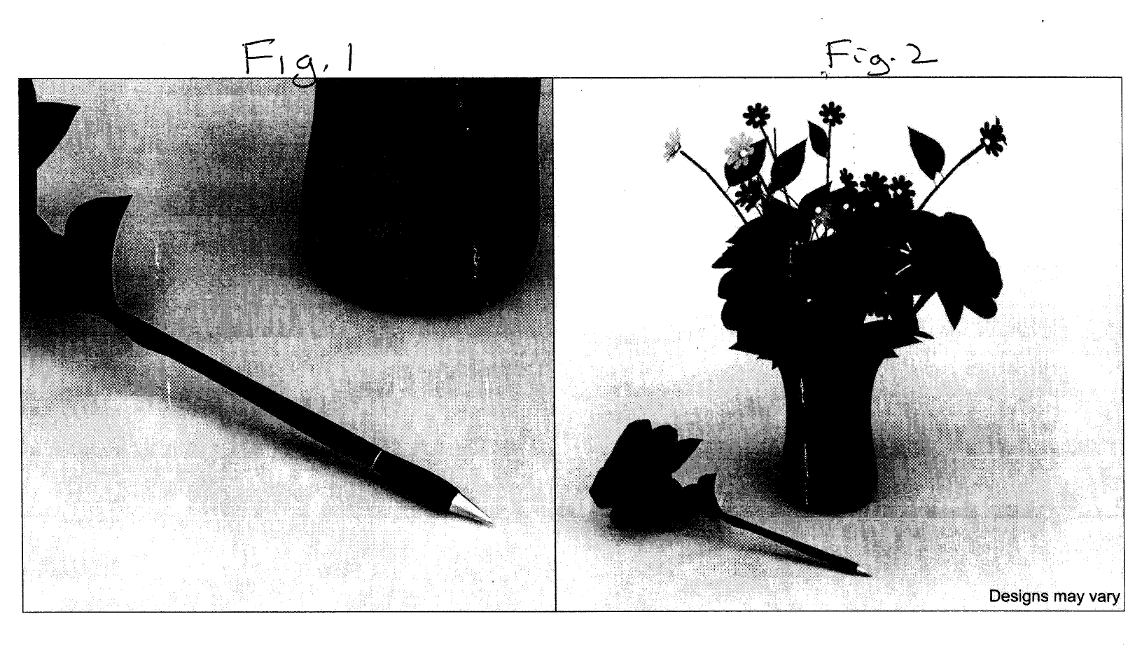

As illustrated in FIGS. 1 and 2, the present invention is floral expressions providing a specially designed line of faux flowers for use in creating any number of elegant arrangements and featuring the a ball point pen incorporated into its stem.

The floral expressions of the present invention can be produced in a myriad of varieties including everything from roses, lilies, daffodils, gardenias, carnations, and daises all offered in the line, to name a few options. Manufactured of silk or synthetic material, these flowers are sized and shaped appropriately to mimic the actual features of the individual flowers represented. Further, the flowers are realistically rendered in natural hues. In addition, each faux flower can be adorned with faux leaves and greenery, adding a realistic final touch to the overall design. Most notably, as opposed to a traditional twisted wire stem, the stem of the floral expressions are comprised of an elongated ball point pen. For practical purposes, the pen can be green in color, mimicking the color of a flower stem. The barrel of this pen features a flexible shaft, thus enabling the user to easily manipulate the pen to create a designated floral arrangement. This pen contains ink produced in any number of colors including black, blue, red or green, with the pen featuring a ball point and removable cap. The floral expressions can be sold individually or in multi-count sets.

Use of the floral expressions of the present invention is very simple and straight forward. Users simply purchase individual or sets of floral expressions to create any number of striking displays. For instance, one may purchase floral expressions featuring delicate lilacs, placing six or seven faux flowers in a glass jar and setting the arrangement on a fireplace mantel or night table. Alternately, an hotelier may utilize arrangements of floral expressions roses to adorn guest suites. As needed, the user removes individual flowers from the display, utilizing the integrated ball point pen to record information, returning it to the vase or holder after use.

The floral expressions of the present invention offer users a number of significant benefits and advantages. Foremost, the floral expressions provide users a striking decorative accent for the home. Beautifully crafted faux or artificial flowers, cleverly incorporated into the design of a ball point pen, the floral expressions offer users a beautiful decorative show piece and handy writing instrument in one, simple to use product. Users will enjoy purchasing individual flowers from the floral expressions line and mixing and matching sets to create beautiful bouquets with which to adorn any room of their home or office. Well suited for business use, floral expressions provide the owners and operators of hotels and motels a simple and elegant way in which to accentuate guest quarters, while also providing guests a charming memento of their visit. Produced in an endless array of colors and designs, there is floral expressions to suit any decorating need. Fun to use, users of all ages will enjoy writing with this these charming novelty pens. Imprinted with promotional advertising, floral expressions provide a unique means of advertising one's business or service. Further, when the ink is depleted from the pen, users can utilize the floral expressions for purely decorative purposes.

The floral expressions of the present invention offer users a convenient decorating tool and handy writing instrument in one, simple to use product. Produced in a myriad of colors and designs, these lovely faux flowers appeal to a wide variety of users.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art.

Moreover, the invention as disclosed herein may be suitably practiced in the absence of the specific elements which are disclosed herein.

What is claimed is:

1. A floral arrangement of artificial flowers wherein the stem of more than one of the flowers in the arrangement comprises a pen.

2. The floral arrangement of artificial flowers of claim 1, wherein the flowers having a pen comprise a flexible shaft, thus enabling the user to easily manipulate the pen to create a designated floral arrangement.

3. An artificial flower having a stem comprising a pen having a flexible shaft.
